(19) United States
(12) Patent Application Publication
(10) Pub. No.: US 2017/0201808 A1
(43) Pub. Date: Jul. 13, 2017

(54) SYSTEM AND METHOD OF BROADCAST AR LAYER

(71) Applicant: Globalive XMG JV Inc., Toronto (CA)

(72) Inventors: Yousuf Chowdhary, Ontario (CA); Steven Blumenfeld, Lafayette, CA (US)

(21) Appl. No.: 15/402,172

(22) Filed: Jan. 9, 2017

Related U.S. Application Data
(60) Provisional application No. 62/276,847, filed on Jan. 9, 2016.

(51) Int. Cl. H04N 21/81; H04N 21/44; H04N 21/8358; H04N 21/61; H04N 21/4223

(52) U.S. Cl. CPC H04N 21/816; H04N 21/6125; H04N 21/4223; H04N 21/8358; H04N 21/44016; G06F 3/041

(57) ABSTRACT

A method is provided for enabling enhanced viewing of a broadcast by a user through an augmented reality device. An application is provided on the augmented reality device which is programmed for acquiring a camera feed of at least a portion of a broadcast displayed on a display device, which includes an AR layer. The camera feed is displayed using the augmented reality device. The application recognizes in the AR layer of the acquired broadcast at least one watermark or image, accesses a database of such watermarks or images, and retrieves related data. The data or an associated virtual object is then rendered as an overlay of the displayed camera feed.

### CROSS REFERENCE TO RELATED APPLICATIONS

This application claims the benefit of U.S. Pat. App. Ser. No. 62/276,847, filed on Jan. 9, 2016, the contents of which are hereby incorporated by reference in its entirety.

### FIELD OF INVENTION

The present invention is related to broadcast and the inclusion of a metadata layer in the broadcast that can be used for augmented reality applications.

### BACKGROUND

Prior art systems and methods exist whereby text, graphics and other information can be embedded in the live images of a broadcast. In some cases text is added to assist viewers, such as Closed Captioning (CC), while in other cases effects enable advertisements and logos to be integrated into the on-air video being telecast.

Closed Captioning (CC) and subtitling are processes of displaying text on a television, video screen, or other visual display to provide additional or interpretive information. Both are typically used as a transcription of the audio portion of a program as it occurs. Closed captioning can be turned on or off using features implemented either in a television, a Set Top Box or similar device. Once Closed Captioning is turned on it is visible to all viewers and tends to block a certain portion of the display screen which can diminish the viewing experience.

EIA-608, also known as “Line 21 captions” and “CEA-608”, used to be the standard for Closed Captioning for NTSC TV broadcasts in the United States, Canada and Mexico. It was developed by the Electronic Industries Alliance and required by law to be implemented in most television receivers. EIA-608 captions are transmitted on either the odd or even fields of line 21 with an odd parity bit in the non-visible active video data area in NTSC broadcasts. It uses a fixed bandwidth of 480 bit/s per line 21 field for a maximum of 32 characters per line per caption (maximum four captions) for a 30 frame broadcast. The odd field captions relate to the primary audio track and the even field captions related to the SAP or secondary audio track which is generally a second language translation of the primary audio, such as a French or Spanish translation of an English-speaking TV show.

The EIA-608 data stream format includes Extended Data Service (XDS), a variety of information about the transmission. This content is optional, and can include channel name, channel call letters, program name, offensiveness rating (violence, sex, etc.), and program category (drama, game show, etc.). There are three sets of characters that the EIA-608 stream can direct the receiver to display: basic characters, special characters, and extended characters.

Prior art techniques like digital compositing allow for the inclusion of transparent objects by proportionally displacing the pixels in one image (foreground) with corresponding pixels of another image containing the augmented objects (background). Yard lines, puck comet trails and logos can be added to the video at the proper locations and with the right perspective to look realistic. But in order to determine proper placement, the field of view (FOV) of the broadcast camera must be computed from data collected from sensors on the cameras and the field. This requires that special cameras be used and the field be pre-prepared in advance with the proper sensors placed at the optimum locations.

Additionally many industries such as broadcasting, videography and film making include techniques for combining images that have been recorded in one environment with those images recorded in another. Chroma keying is a standard technique that replaces the original blue screened background with that of the special effect, for instance, a more interesting geographical location, giving the illusion of an actor submerged in a more intriguing environment. The resulting image is called the composite image. For example, a weather forecaster may be depicted in front of an augmented animated weather map, while in reality the forecaster is standing in front of a blue screen. Likewise, an actor may be filmed in the controlled environment of a studio while they appear to the audience to be in a different setting e.g. heading to South Pole or climbing Mount Kilimanjaro. Such techniques cannot be used for live events.

Above mentioned prior art techniques add a lot of visual information that ends up cluttering the view which results in the viewer getting distracted.

On the spectrum between virtual reality, which creates immersive, computer-generated environments, and the real world, augmented reality is closer to the real world. Augmented reality (AR) refers to the addition of a computer-assisted contextual layer of information over the real world, creating a reality that is enhanced or augmented. The basic idea of augmented reality is to superimpose information in the form of data, graphics, audio and other sensory enhancements (haptic feedback and smell) over a real-world environment as it exists in real time. While augmented reality has been in existence for almost three decades, it has only been in the last few years that the technology has become fast enough and affordable enough for the general population to access. Both video games and cell phones are driving the development of augmented reality. Everyone from tourists, to soldiers, to someone looking for the closest subway stop can now benefit from the ability to place computer-generated information and graphics in their field of vision.

The augmented reality systems use video cameras and other sensor modalities to reconstruct a mixed world that is part real and part virtual. Augmented Reality applications blend virtual images generated by a computer with a real image (for example taken from a camera) viewed by a user.

There are primarily two types of Augmented Reality implementations namely Marker-based and Markerless:
Marker-based implementation utilizes some type of image such as a QR/2D code to produce a result when it is sensed by a reader, typically a camera on a mobile device e.g. a Smartphone
Markerless AR is often more reliant on the sensors in the device being used such as the GPS location, velocity meter, etc. It may also be referred to as Location-based or Position-based AR.

While Markerless Augmented Reality is emerging many markerless AR applications require the use of a built-in GPS to access content tied to a physical location thus superimposing location-based virtual images over the real-world camera feed. Although these capabilities can allow a user to approach a physical location, see digital content in the digital airspace associated with that physical location, and engage with the digital content; such technologies have serious limitations as built-in GPS devices have limited accuracy, cannot work indoors or underground, and may require that a user be connected to a network via WiFi or 4G.

It would be desirable to use the emerging technologies of Augmented Reality to enhance the user experience of viewing a broadcast.

### SUMMARY

Broadly speaking, the present invention provides a system and method of an AR layer in broadcast. A broadcast layer of metadata is provided that can be used by an AR application to recognize TV programming and then enhance the programming by injecting virtual objects, text, graphics, audio, video and the like through the AR device that relate to the programming that is being broadcast. This enables a unique and more enjoyable Augmented Reality experience for an audience watching sports or other programming on television.

In one embodiment a unique digital “watermark” enables the recognition of the TV programming. The watermark can be recognized by the AR app which then injects associated digital content in the Augmented Reality space of an AR device when a user is watching television. In some embodiments a set of digital content may be uniquely associated with a given watermark.

In one embodiment a user launches an app on a mobile device e.g. a tablet or a Head Mounted Device (HMD). The app may be either generic or purpose built, which allows a user to interact with the functionality provided by the system. In one embodiment an application (app) may be directly built into the mobile device's operating system (e.g.: IOS, Android, Windows, OSx, Linux, Chrome etc.), which allows a user to interact with the functionality provided by the system. A graphical user interface may be provided for a user to interact with the app features and to personalize for individual needs.

Preferably the app has the capability to connect to the internet and also provides a user interface through which the user may be able to log in or out of the system. The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices for an Augmented Reality experience e.g. a Smartphone, a tablet, or a personal computer to connect with the system e.g. via an app on a mobile device. Devices where the invention can be advantageously used may include but are not limited to an iPhone, iPad, Smartphones, Android phones, Head Mounted Displays (HMDs), Google-Glass, e-readers, wearable devices, personal computers e.g. laptops, tablet computers, touch-screen computers and other devices that have a display and are portable running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, one or more cameras, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

In one embodiment the user points the AR device camera at a TV broadcast on display. It is to be understood that TV and such programming is distributed to the users in many different ways. The traditional model is transmission of TV programming on air broadcast (wireless transmission of signal), as well as cable or satellite based distribution in which cases the user premises requires a Set Top Box to decode the received signal and then displays it on a monitor.

Internet Protocol Television (IPTV) is a system through which television services are delivered using the Internet Protocol (IP) suite over a packet-switched network like the Internet or a LAN (Local Area Network), instead of being delivered through traditional terrestrial, satellite signal, and cable television formats. IPTV offers the ability to stream the media in smaller batches, directly from the source. As a result, a user premises media player can begin playing the data (such as a movie) before the entire file has been transmitted. IPTV services may be classified into three main categories namely Live television, Time-shifted television and Video on demand (VOD).

Hybrid IPTV refers to the combination of traditional broadcast TV services and video delivered over either managed IP networks or the public Internet. It is an increasing trend in both the consumer and pay TV markets.

IP-based platforms allow for significant opportunities to make the TV viewing experience more interactive and personalized. They may include an interactive program guide that allows users to search for content by title or actor's name, or a picture-in-picture functionality that allows them to “channel surf” without leaving the program they're watching. Users may also be able to look up a player's stats while watching a sports game, or control the camera angle. Users may also be able to access photos or music from their PC on their television, use a wireless phone to schedule a recording of their favorite shows and adjust parental controls.

“Watermarking” is the process of hiding information in an item of value to identify and establish its ownership. A watermark is an identifying image or pattern, originally used with paper and paper based products like currency notes, stamps etc. A paper based watermark is such that it appears as various shades of lightness/darkness when viewed by transmitted light (or when viewed by reflected light, atop a dark background), caused by thickness or density variations in the paper.

Digital Watermarking is the process of hiding digital information in a carrier signal. It is a process of embedding information into a signal (e.g. audio, video or pictures) in a way that is difficult to remove it without destroying the original. A digital watermark is a marker covertly embedded in a noise-tolerant signal such as audio, image, pictures, video, texts or 3D models. A signal may carry several different watermarks at the same time. Thus when a signal embedded with a digital watermark is copied, the watermark information is also carried in the copy.

An audio watermark is a unique electronic identifier embedded in an audio signal. One of the most secure techniques of audio watermarking is spread spectrum audio watermarking (SSW). In SSW, a narrow-band signal is transmitted over a much larger bandwidth such that the signal energy presented in any signal frequency is undetectable. Thus the watermark is spread over many frequency bands so that the energy in one band is undetectable.

The preferred embodiment uses image based or visual watermarks, other embodiments may use audio watermarks, or watermarks based on a combination of image and audio as well as other technologies like NFC that can be advantageously used to identify the TV program or the components of it to inject the appropriate digital content in the AR space.

In one embodiment the augmented reality (AR) device gets a data feed using the camera feed as the background for the display. For example if a user is watching a sports program e.g. a baseball game, the AR device camera pointing at the TV will result in the images on the TV screen to be shown on the AR device screen.

In one embodiment the AR device recognizes the “watermark” that is transmitted in the AR data layer by recognizing the specific images within the TV broadcast on the screen. Multiple methods for TV broadcast recognition may be used.

In one embodiment the AR device overlays pertinent information from data feed or other source e.g. the internet, Wikipedia, social networks e.g. Facebook, STATs networks for sports etc. on the TV broadcast as it is captured and displayed on the AR device screen.

In one embodiment the app injects digital content in the AR space using the camera feed as the background. The digital content may contain text, graphics, video, audio and other sensory enhancements to create a realistic augmented reality experience for the user.

In one embodiment the user moves/points the AR device (camera) to another part of the TV broadcast screen, and new information such as text, graphics, virtual objects, audio, and video is overlaid on the camera feed. The information can be provided in various formats and in various different combinations that are suitable to the application and implementation.

In some embodiments once the digital content has been injected into the AR space, a user may be able to interact with such content. User interaction can include manipulating the injected digital object by moving, expanding, contracting, walking through, linking, sharing and changing certain characteristics.

In one embodiment a user launches the app on a mobile device. The app may be either generic or purpose built, which allows a user to interact with the functionality provided by the system. In one embodiment an application (app) may be directly built into the mobile device's operating system (e.g.: IOS, Android, Windows, OSx, Linux, Chrome etc.), which allows a user to interact with the functionality provided by the system. A graphical user interface may be provided for a user to interact with the app features and to personalize for individual needs.

The user may use any one of the several possible mechanisms to interact with the digital content injected in the AR space including but not limited to a touchscreen, keyboard, voice commands, eye movements, gamepad, mouse, joystick, wired game controller, wireless remote game controller or other such mechanism.

According to one embodiment a user may optionally have to provide a user name and a password along with other personal or financial information in order to create an account. Personal information for example may include providing address and date of birth (age), gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate content in the AR space that fits the user profile.

According to one embodiment a user may optionally provide access to the user's social graph or online personality to ascertain personal, family, friend's, acquaintance's information including but not limited to location, address and date of birth (age), gender, sexual orientation, family status and size, tastes, likes and dislikes and other information related to work, habits, hobbies etc. Preferably financial information may include providing a credit card number, an expiry date and billing address or other information like PayPal account details etc. In one embodiment based on the user preferences and profile of a user inject digital content that is relevant to the user.

In one embodiment age appropriate content may be displayed to a user based on the user's age; while the complexity and the extent of the content may also vary with age e.g. teens may be provided with a set of easy to understand information including gamified content (concept of applying game mechanics and game design techniques to engage and motivate users to achieve their goals); while older adults may be provided more in depth commentary and details. Preferably a user may be able to control the complexity and the extent of the content that is injected into the AR space e.g. a teen who is keenly interested in an artifact may want further information after having experienced the age appropriate content.

In some embodiments the digital content injected in the AR space may be based on past experience and behavior of a user in addition to the user profile and preferences; e.g. previous patterns of movement, areas of interest etc. may have an impact on the types and extent of the digital content that is displayed.

In some embodiments the digital content injected to in the AR space may be based on user behaviour e.g. browsing history captured via cookies. In some embodiments the invention itself may create cookies for storing history specific to the Augmented Reality. Such cookies may maintain a complete or partial record of the state of an object and maintain a record of AR objects (data) that may be used at specific locations amongst other data that may be relevant to an AR experience.

In one embodiment the user may preferably have the means for controlling the type, extent and complexity of the digital content being injected in the AR space by using a GUI (Graphical User Interface) in the app to manage the settings.

According to a first aspect of the invention, a method is provided for enabling enhanced viewing of a broadcast by a user through an augmented reality device. An application is provided on the augmented reality device which is programmed for acquiring a camera feed of at least a portion of a broadcast displayed on a display device, which includes an AR layer. The camera feed is displayed using the augmented reality device. The application recognizes in the AR layer of the acquired broadcast at least one watermark or image, accesses a database of such watermarks or images, and retrieves related data. The data or an associated virtual object is then rendered as an overlay of the displayed camera feed.

The camera feed and the overlay may be displayed on a screen of the augmented reality device. The user may be permitted to interact with the camera feed or the overlay on the screen of the augmented reality device (e.g. a touchscreen).

Alternatively, or in addition, at least a portion of the camera feed or the overlay may be displayed in a 3D representation anchored to a particular volume of airspace (i.e. in AR space associated with the augmented reality device). The 3D representation may be manipulable by the user virtually touching the 3D representation in AR space, such as by: resizing, rescaling, relocating, zooming in/out, selecting, or reorienting the 3D representation. Manipulators may be provided for the user to perform interactions on the 3D representation. Selecting may include linking, sharing, or changing characteristics, or other functions.

In one embodiment, the watermark is a digital watermark which is substantially invisible to a viewer of the broadcast on the display device.

The at least one watermark or image may include a plurality of watermarks or images, each being associated with distinct data.

The image may comprise an image of a character, place or scene in the broadcast. Alternatively, the image may comprise a logo associated with a channel or network. Alternatively, the image may comprise a QR code.

In one particular example, the broadcast is a sports broadcast and the data includes at least one statistic.

Preferably, retrieving related data includes retrieving data from linked databases. For example, the linked databases may include at least one of program guide, wiki or other encyclopedic source, social media, statistical, or newsfeed databases.

The associated virtual object may include a virtual character or avatar.

The method may further comprise retrieving information about the user through the application and tailoring the data or associated virtual object according to at least one interest or demographic variable of the user. For example, the information may be in a profile associated with the user, such as a social media profile. The demographic variable may comprise, for example, the age or gender of the user. The interest may be an expressed preference of the user, or a preference gathered (or inferred) from past viewing or browsing behaviour of the user.

While various implementations are possible, the augmented reality device may be, for example, a smartphone or a head-mounted device. The display device may be a television (or any other device capable of displaying a streamed television broadcast).

### BRIEF DESCRIPTION OF THE FIGURES

FIG. 1 is a flow diagram of a basic outline of the present method.

FIG. 2 is a simplified network diagram showing display and data feed sources.

FIG. 3 is a flow diagram of a method of receiving and displaying AR data layer enhanced broadcast.

FIG. 4 is a flow diagram of watermark detection method.

FIG. 5 is a flow diagram of image recognition and contextual data retrieval.

FIG. 6 is a flow diagram of channel and program data contextual data retrieval.

FIG. 7 is a simplified network diagram showing separate devices retrieving information from separate watermarks on a broadcast.

### DETAILED DESCRIPTION

Methods and arrangements are provided for an Augmented Reality layer in a broadcast as metadata that enables the injection of digital content in the AR space to provide additional information or enhance the entertainment value of the broadcast. The application relates to and builds upon prior inventions of the applicants, described in U.S. patent application Ser. No. 15/229,066, filed Aug. 4, 2016, and U.S. patent application Ser. No. 15/272,056, filed Sep. 21, 2016, both of which are incorporated herein by reference.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, it will be understood that, in at least one embodiment, the components comprised in the method and tool are actually implemented in software.

As will be appreciated, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Python, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

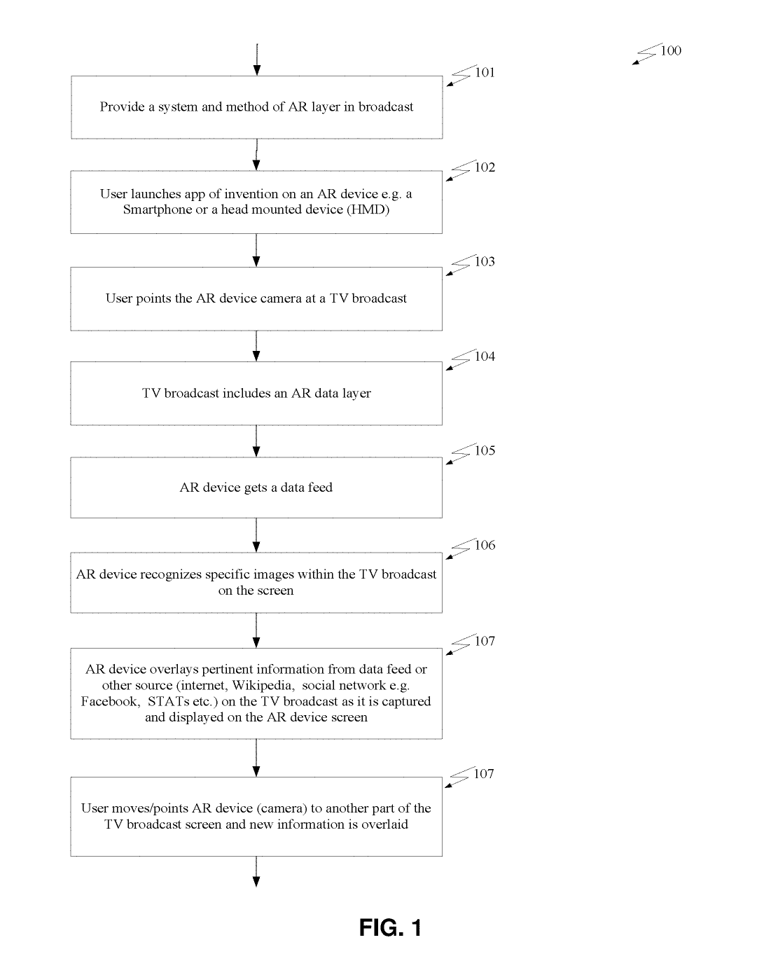

FIG. 1 shows the basic flow of the main method 100. A system and method are provided for inclusion and use of an AR layer in a broadcast.

An AR layer is provided in a broadcast 101. This enables the recognition of the TV programming by for example injecting a unique “watermark” which can be recognized by the AR app for injecting the appropriate digital content in the Augmented Reality space of an AR device when a user is watching television.

The user preferably launches an app on an AR device e.g. a Smartphone or a Head Mounted Display (HMD) 102. In one embodiment a user launches app on a mobile device e.g. a tablet. In one embodiment an application (app) may be provided (either generic or purpose built), which allows a user to interact with the functionality provided by the system. In one embodiment an application (app) may be directly built into the mobile device's operating system (e.g.: IOS, Android, Windows, OSx, Linux, Chrome etc.), which allows a user to interact with the functionality provided by the system. A graphical user interface may be provided for a user to interact with the app features and to personalize the operations and output for individual needs.

Preferably the app has the capability to connect to the internet and also provides a user an interface which the user may be able to log in or out of the system. The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices for an Augmented Reality experience e.g. a Smartphone, a tablet, or a personal computer to connect with the system e.g. via an app on a mobile device. Devices where invention can be advantageously used may include but not limited to an iPhone, iPad, Smartphones, Android phones, Head Mounted Displays (HMDs), Google-Glass, e-readers, wearable devices, personal computers e.g. laptops, tablet computers, touch-screen computers and other devices that have a display and are portable running any number of different operating systems e.g. MS Windows, Apple iOS, Linux, Ubuntu, etc.

An HMD is a display device, worn on the head or as part of a helmet, that has a small display optic in front. A typical HMD has either one (monocular HMD) or two (binocular HMD) small displays with lenses and semi-transparent mirrors embedded in a helmet, eyeglasses (also known as data glasses) or a visor. The display units are miniaturized and may include CRT, LCDs, Liquid Crystal on Silicon (LCos), or OLED. Some HMDs employ multiple micro-displays to increase total resolution and field of view (FoV).

In some embodiments, the device is portable. In some embodiments, the device has a touch-sensitive display with a graphical user interface (GUI), one or more processors, one or more cameras, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

The user points the AR device camera at a TV broadcast 103, e.g. on a display device. It is to be understood that TV and such programming is distributed to the users in many different ways. The traditional model is transmission of TV programming on air broadcast (wireless transmission of signal), as well as cable or satellite based distribution in which cases the user premises requires a Set Top Box to decode the received signal and then displays it on a monitor.

Internet Protocol Television (IPTV) is a system through which television services are delivered using the Internet Protocol (IP) suite over a packet-switched network like the Internet or a LAN (Local Area Network), instead of being delivered through traditional terrestrial, satellite signal, and cable television formats. IPTV offers the ability to stream the media in smaller batches, directly from the source. As a result, a user premises media player can begin playing the data (such as a movie) before the entire file has been transmitted. IPTV services may be classified into three main categories namely Live television, Time-shifted television and Video on demand (VOD).

Hybrid IPTV refers to the combination of traditional broadcast TV services and video delivered over either managed IP networks or the public Internet. It is an increasing trend in both the consumer and pay TV markets.

IP-based platforms allow for significant opportunities to make the TV viewing experience more interactive and personalized. It may include an interactive program guide that allows users to search for content by title or actor's name, or a picture-in-picture functionality that allows them to “channel surf” without leaving the program they are watching. Users may also be able to look up a player's stats while watching a sports game, or control the camera angle. Users may also be able to access photos or music from their PC on their television, use a wireless phone to schedule a recording of their favorite shows and adjust parental controls.

In one embodiment users may use connected devices e.g. a Smartphone, a tablet, a HMD, and the like. Devices where invention can be advantageously used may include but not limited to an iPhone, iPad, Smartphones, Android phones, e-readers, Head Mounted Devices (HMD) or other wearable devices, personal computers e.g. laptops, tablet computers, touch-screen computers, other devices with displays that are portable running any number of different operating systems e.g. MS Windows, Apple iOS, Linux, Chrome, Ubuntu, etc.

The TV broadcast includes an AR data layer 104. In one embodiment TV broadcast includes an AR data layer that may include a “watermark” that is recognizable by the app and facilitates the injection of appropriate digital content e.g. virtual objects in the augmented reality space. Each watermark may have a certain set of digital content associated with it. In some embodiments a set of digital content may be uniquely associated with a given watermark.

The AR device gets a data feed 105. In one embodiment augmented reality (AR) device gets a data feed using the camera feed as the background for the display. For example if a user is watching a sports program e.g. a baseball game, the AR device camera pointing at the TV will result in the images on the TV screen to be shown on the AR device screen.

The AR device preferably is programmed to recognize specific images within the TV broadcast on the screen 106. In one embodiment the AR device recognizes the “watermark” that is transmitted in the AR data layer by recognizing the specific images within the TV broadcast on the screen. Multiple methods for TV broadcast recognition may be available and some of the preferred methods are described in more detail later in this disclosure.

The AR device overlays pertinent information from data feed or other source on the TV broadcast as it is captured and displayed on the AR device screen 107. Examples of such data feeds and sources include the internet, Wikipedia, social networks e.g. Facebook, STATs networks etc. The data retrieved can then be overlaid on the TV broadcast as it is captured and displayed on the AR device screen.

Preferably, the app injects digital content in the AR space using the camera feed as the background. The digital content may contain text, graphics, video, audio and other sensory enhancements to create a realistic augmented realty experience for the user.

When the user moves/points AR device (camera) to another part of the TV broadcast screen, new information is preferably overlaid 108. In one embodiment the user moves/points AR device (camera) to another part of the TV broadcast screen and new information like text, graphics, virtual objects, audio, and video are overlaid on the camera feed in any different combinations that are suitable to the application and implementation.

“Watermarking” is the process of hiding information in an item of value to identify and establish its ownership. A watermark is an identifying image or pattern, originally used with paper and paper based products like currency notes, stamps etc. A paper based watermark is such that it appears as various shades of lightness/darkness when viewed by transmitted light (or when viewed by reflected light, atop a dark background), caused by thickness or density variations in the paper.

Digital Watermarking is the process of hiding digital information in a carrier signal. It is a process of embedding information into a signal (e.g. audio, video or pictures) in a way that is difficult to remove it without destroying the original. A digital watermark is a marker covertly embedded in a noise-tolerant signal such as audio, image, pictures, video, texts or 3D models. A signal may carry several different watermarks at the same time. Thus when a signal embedded with a digital watermark is copied, the watermark information is also carried in the copy.

An audio watermark is a unique electronic identifier embedded in an audio signal. One of the most secure techniques of audio watermarking is spread spectrum audio watermarking (SSW). In SSW, a narrow-band signal is transmitted over a much larger bandwidth such that the signal energy presented in any signal frequency is undetectable. Thus the watermark is spread over many frequency bands so that the energy in one band is undetectable.

The preferred embodiment uses image based or visual watermarks, other embodiments may use audio watermarks, or watermarks based on a combination of image and audio as well as other technologies like NFC that can be advantageously used to identify the TV program or the components of it to inject the appropriate digital content in the AR space.

In some embodiments once the digital content like text, graphics, virtual objects, audio, and video has been injected into the AR space, a user may be able to interact with such content e.g. user interaction can consist of manipulating the injected digital object by moving, expanding, contracting, walking through, linking, sharing and changing certain characteristics.

In one embodiment 3D widgets also known as manipulators can be used to put controls on the injected 3D digital representations. Users can then employ these manipulators to re-locate, re-scale or re-orient the 3D digital representation (Translate, Scale, Rotate).

Optionally a user may have to provide a user name and a password along with other personal or financial information in order to create an account. Personal information for example may include providing address and date of birth, gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate ads that fit the user profile.

According to one embodiment a user may optionally provide access to the users social graph or online personality to ascertain personal, family, friend's, acquaintance's information including but not limited to location, address and date of birth (age), gender, sexual orientation, family status and size, tastes, likes and dislikes and other information related to work, habits, hobbies etc. Preferably financial information may include providing a credit card number, an expiry date and billing address or other information like PayPal account details etc.

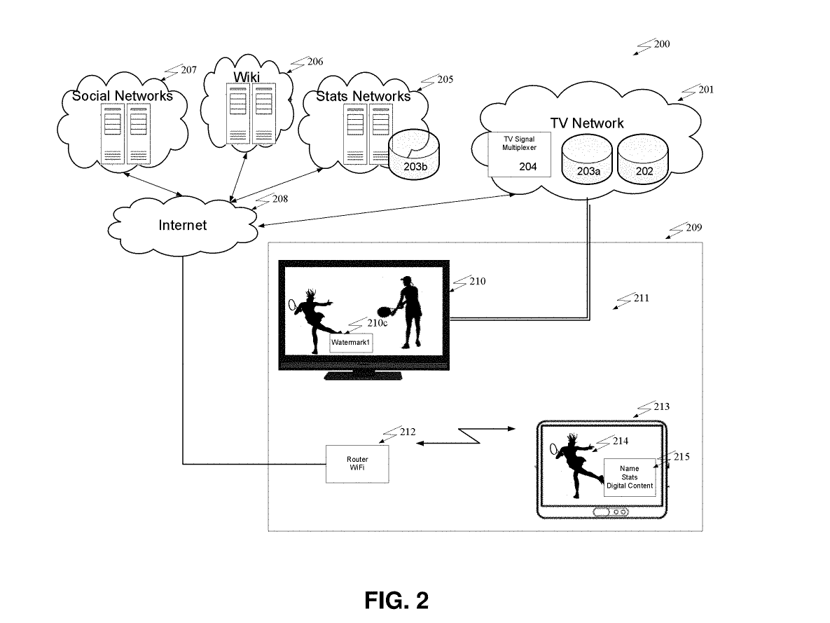

Referring now to FIG. 2, there is shown a simplified network diagram of the different sub-systems that enable the patent according to the preferred embodiment 200.

FIG. 2 shows the TV network 201. A TV network is a telecommunications network for the distribution of television programming content in which a central operation provides programming to multiple television stations or pay television providers. For example the American Broadcasting Company (ABC) is an American commercial broadcast television network that owns and operates eight television stations of its own and has an affiliation with several hundred other television stations.

TV programming database 202 is a database that stores the programming schedule information. TV programming data is usually available in advance from the different TV networks and is often assembled by aggregators of such data.

Watermark database 203a represents the watermarks associated with the many channels, TV programs, serials, actors, games, leagues, players and makes it available for these watermarks to be layered in the TV signal transmission as well as making these available online either directly or via the sports or other databases that store information about games, players, historical seasons, scores, etc. Such a database of watermarks may comprise an aggregate of watermarks that may be acquired from multiple sources over a period of time and augmented with realtime data received as RSS feeds from other providers.

TV signal multiplexing equipment 204 represents the television network infrastructure that enables the combining of different programming signals both analog and digital data streams to be combined into one signal over a shared medium for transmission. An AR data layer with information to create a unique and recognizable “watermark” is included in the TV programming via multiplexing. In some embodiments of the invention more than one unique “watermarks” may be added in the same frame such that each watermark has a unique and different content set associated with it. It may be noted that the unique watermark may or may not be visible to the user, but is recognizable by the app that is running on the AR device.

The multiplexed signal is transmitted over a communication channel, such as a cable. The multiplexing divides the capacity of the communication channel into several logical channels, one for each message signal or data stream to be transferred. A reverse process, known as demultiplexing, extracts the original channels on the receiver end.

In video editing and processing systems, multiplexing refers to the process of interleaving audio and video into one coherent MPEG transport stream (TDM). In digital video, such a transport stream is normally a feature of a container format which may include metadata and other information, such as subtitles. The audio and video streams may have variable bit rate. Software that produces such a transport stream and/or container is commonly called a statistical multiplexer. A demuxer is software that extracts or otherwise makes available for separate processing the components of such a stream or container.

In digital television and digital radio systems, several variable bit-rate data streams are multiplexed together to a fixed bit-rate transport stream by means of statistical multiplexing. This makes it possible to transfer several video and audio channels simultaneously over the same frequency channel, together with various services.

Stats networks 205 represent the many online resources that aggregate sports related data. Many online systems and stats data aggregators provide enhanced sports information via highly customizable feeds to either other systems or end users. Some systems may also provide real-time player tracking data for sports statistics by using real-time player and ball positioning tracking technologies. Whereas predictive data feeds may also provide insights on probabilities for game outcomes based on many different factors like history, current dynamic of the game, player performance, etc.

Stats database 203b represents the many online sports or other databases that store information about games, players, historical seasons, scores, etc. Databases 203a may be the source of the watermarks and these may be made available via online storage in a database 203b. Such information may be complementary when they are unique and independent or they may have a small or a significant overlap in the information that is stored there.

Wiki and other resources on the internet 206 represent the various knowledge bases (encyclopedic and otherwise) that are available online for access to publically available information about almost anything imaginable.

Social networks 207 represents social media sources for example Facebook or Google+. A social networking service is an online service or a platform or a website that provides the means for people to build their social networks reflecting their social relationships with other people. Typically a social network service consists of a representation of each person via a profile, each person's social connections and their interests. Today most social networking services are web-based and also provide means for people to interact with each other through e-mail, instant messaging, online chats etc. Social networking websites allow people to share ideas, activities, events, and interests within their individual networks.

Facebook, Twitter, LinkedIn and Google+ are examples the most popular social networking websites. Social networking websites share a variety of technical features. The most basic of these are visible profiles usually with a list of “friends” who are also users of the site. Some social networking websites allow people to upload pictures, add multimedia content to uniquely individualize the look and feel of their profiles. Profiles often have a section dedicated to comments from friends and other users. To protect user privacy, social networks typically have controls that allow users to choose who can view their profile, contact them, add them to their list of contacts, and so on.

Internet 208 enables the different entities and sub-systems to connect, communicate and exchange data.

User premises 209 includes, for example, a house or an office where the user is watching TV 210 or watching TV programming received by a Set Top Box which is connected to a display device e.g. a monitor and displays the watermark 210c which may not be perceptible to the naked human eye.

Cable or fiber 211 connects the TV 210 (or the Set Top Box) to the TV networks 201; this may also include satellite signal, internet transmitted IP TV, and the like.

Router or WiFi 212 provides internet access to the devices located in the user premises 209 and enables these devices to access data and content from online resources.

An AR device 213 is provided, such as a Smartphone with the app running on it, or a HMD worn by a user that is enabling the augmented reality experience.

When the user focuses the AR device on an item 214 e.g. a particular player on the viewing screen of the TV 210, the camera feed provides the background for the AR experience. For example in a tennis match there are usually two or four players, thus the AR device camera may be pointing towards one of these players.

Injected digital content 215 is super-imposed on the camera feed that provides the background for the AR device 213 augmented reality experience. Thus information about the tennis player of our example is injected into the AR space on the AR device.

The injected information is preferably only available to the user wearing the HMD or looking at the screen of a Smartphone that is pointing towards the TV and where the app is running. The video images on the TV or monitor remain uncluttered as the “watermarks” added by the AR layer may not be noticeable by the naked eyes of a user. The stats or other information is preferably only available to a particular user who is using the AR device while the other viewers enjoy the real experience without sacrificing any portion of the TV screen or having unwanted information clutter the TV screen.

The experience is akin to a person watching a stage show and occasionally using opera glasses or theater binoculars to focus on a particular actor to a get a better view.

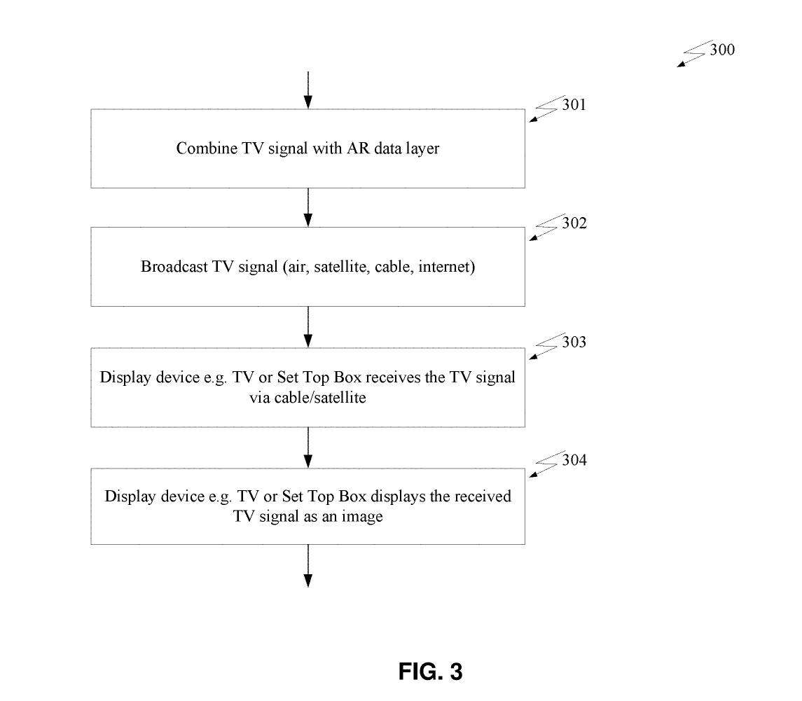

Referring now to FIG. 3, there is shown a flow chart of a method of receiving and displaying AR data layer enhanced broadcast 300.

The TV signal is combined with an AR data layer 301. The AR data layer preferably has the information to create a “watermark” on the TV display that is recognizable by the AR app running on the AR device; but may not be noticeable to the naked eye of a viewer.

A watermark may be unique, and each program or each episode of a series, or each scene, actor, singer, league, team, season, game, player, manager etc. may have a different and unique watermark associated with it. And by recognizing the watermark and comparing it against a database of watermarks that may contain all or select watermarks uniquely associated with TV programs, series, episodes, scenes, players, actors, directors etc. appropriate digital information may be injected in the AR space.

In the preferred embodiment there may be at least two or more types of watermarks. A first type of watermark may be static watermarks that remain uniquely the same over a longer period of time, e.g. a watermark uniquely associated with a given player or a given team.

A second type of watermark may be dynamic watermarks that continue to change with time as they may have a notion of time/clock so that e.g. current date and time information, or the time of the scene may be encoded in it. In the dynamic watermarks the information embedded in them continues to be dynamically modified/updated e.g. as a game progresses the watermark associated with the odds of winning continues to change.

The TV signal is broadcast 302 via any of the different mechanisms e.g. on air terrestrial wireless transmission, satellite transmission, cable, fiber, internet or any other medium conducive for the particular application and embodiment. The Broadcast TV signal includes the AR data layer that has information for creating one or more unique “watermarks” on the TV display.

In an alternate embodiment the AR data layer may include information other than the watermark, and such information may be used for enhancing the AR experience of a user more unique and meaningful. For example adding a QR code to the TV image and the app of the invitation then recognizes the QR code and augments reality by injecting the information associated with the QR code.

In one embodiment, the Set Top Box receives the TV signal via cable/satellite 303. In other embodiments the Set Top Box may receives the TV signal via cable, fiber, satellite, internet or any of the other transmission mechanisms.

The Set Top Box displays a TV image on a TV screen 304. In one embodiment this includes one or more unique “watermarks” in addition to the regular TV programming.

It is to be understood that “TV” may include any other display device—including a computer, a monitor, a projector, a HMD, a wearable display, or any other device capable of receiving data/TV signals and displaying programming images.

In one embodiment the “watermark” and or player or scene detection algorithm may execute locally on the user's AR device while in another embodiment of the invention it may execute on a remote server that is accessible over a network e.g. the internet. In the embodiment where the processing is done remotely, an image from the user's AR device is sent over a connection (wired/wireless/optical etc.) to a remote computing device (e.g. a standalone computer or a server farm) where the “watermark” or player/scene detection algorithm is executed. The computed results can then be used by the remote server to select the appropriate digital content related to the recognized unique “watermark” or player/scene to be sent to the user's AR device for insertion into the AR space super-imposed over the image of the camera feed.

In some embodiments the system may use a continuous process for example the video stream or a series of stills may be continuously used for acquiring a key frame and then detecting and recognizing in the key frame the “watermark(s)” that is injected as the AR layer in the transmitted TV signal for the recognition of a program player/scene/actor etc.

In one embodiment different users using multiple AR devices, each may experience a different augmented reality as their AR device camera may be pointing at a different part of the TV screen and may have a different player or actor in focus. Thus in a tennis match with two players, two users may get different AR experience as a first user focuses on a first tennis player while a second user focuses on a second tennis player. Thus the different digital content that are related to the subject of interest is injected for the two users. Additionally each user may have different user preferences and profiles; and the injected digital content may depend on these settings. In such an embodiment of the invention preferably more than one unique watermark may be added to the TV transmission via the AR data layer such that each player may have a different and unique watermark associated with her.

In some embodiments the digital content injected may be based on past experience and behavior in addition to the user profile and preferences; e.g. previous patterns of sports watching, areas of interest, team or players on preference list etc. may have an impact on the types and extent of the digital content that is displayed.

In some embodiments the digital content injected may be 2D or 3D digital content injected in the AR space and may be based on the user's social profile, interaction with social media and friends along with previous history e.g. past games watched, teams and players followed, and tags on a social network like Facebook.

In some embodiments the digital content injected may be based on user behaviour e.g. browsing history captured via cookies. In some embodiments the app itself may create cookies for storing history specific to the Augmented Reality. Such cookies may maintain a complete or partial record of the state of an object and maintain a record of AR objects (data) that may be used at specific locations amongst other data that may be relevant to an AR experience.

In some embodiments the digital content injected may be based on user behaviour e.g. browsing history captured via cookies. Websites store cookies by automatically storing a text file containing encrypted data on a user's computing device e.g. a Smartphone or a browser the moment the user starts browsing on an online webpage. There are two types of cookies, permanent and temporary cookies. Both have the same capability, which is to create a log/history of the user's online behavior to facilitate future visits to the said website. In Cookie profiling, or web profiling cookies are used to collect and create a profile about a user. Collated data may include browsing habits, demographic data, and statistical information amongst other things and is used for targeted marketing. Social networks may utilize cookies in order to monitor its users and may use two kinds of cookies; these two are inserted in the browser when a user signs up, while only one of them is inserted when a user lands on the homepage but does not sign up. Additionally, social networks may use different parameters for logged-in users, logged-off members, and non-members.

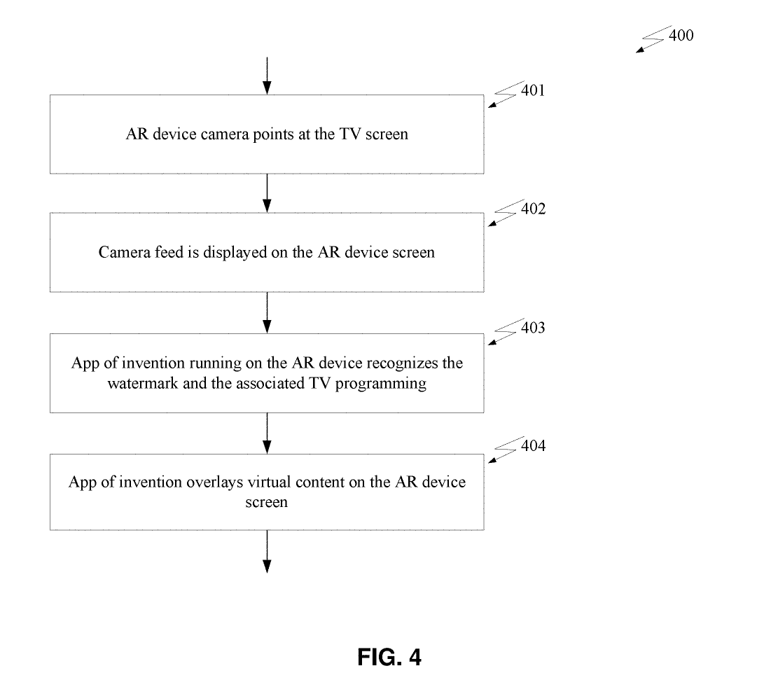

Referring to the method 400 shown in FIG. 4, an AR device camera points at the TV screen 401. For example a user may be using a Head Mounted Device (HMD) which has a camera built in it and a screen on which augmented reality images are displayed. The user moves his/her head in the direction of the TV screen and has the TV image on display in the built in screen of the HMD.

The camera feed is displayed on the AR device screen 402. The screen of the HMD displays the camera feed as the background and the virtual objects are injected/superimposed on this background to create an augmented reality experience.

The app running on the AR device recognizes the watermark and the associated TV programming 403. In one embodiment app running on the AR device recognizes the one or more watermark(s) that was injected via the AR data layer in the TV signal being transmitted; and by recognizing the watermark which is unique the associated TV programming can also be recognized.

In some embodiments one or more watermarks may be used for defining the digital information that is injected in the AR space, e.g. a first watermark that uniquely identifies a player and a second watermark that uniquely identifies the channel.

There may be other methods for recognizing the TV programming and some are described in more detail in later figures.

The app overlays virtual objects on the AR device screen 404. These virtual objects can include but are not limited to text, graphics, virtual 2D and 3D objects, avatars, audio, video and the like related to the TV program on the AR device screen using the camera feed as the background to create an augmented reality experience.

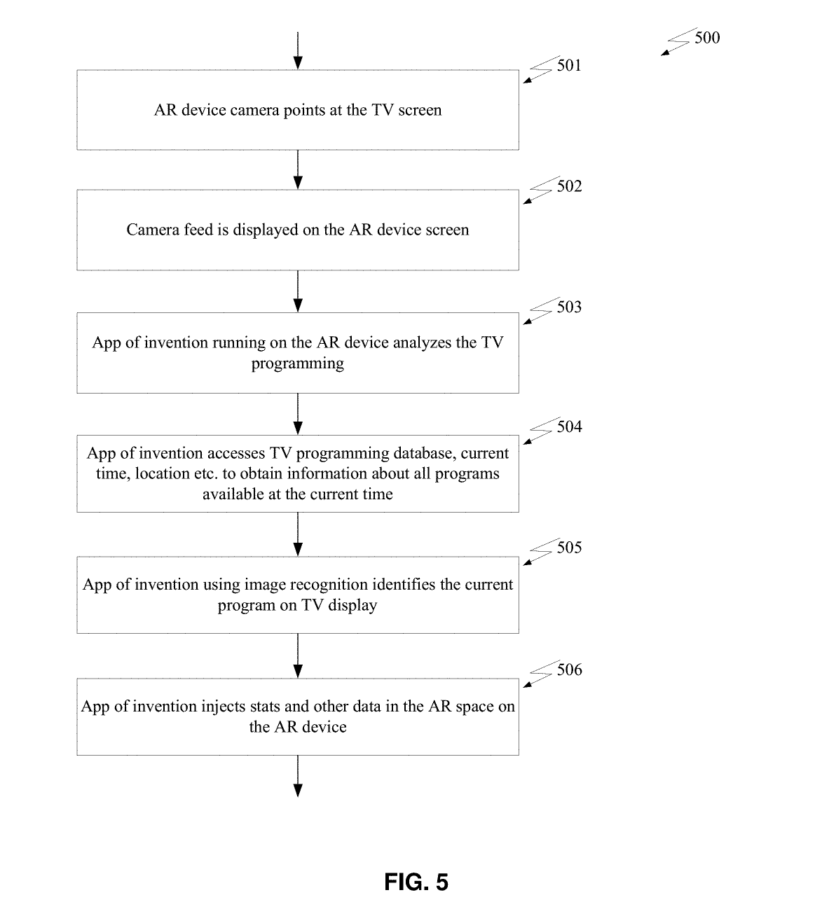

FIG. 5 shows a flow chart of a process for the identification of the TV programming and the injection of appropriate digital content in the Augmented Reality space 500.

The AR device camera points at the TV screen 501. In one embodiment an HMD camera points at the TV screen.

The camera feed is displayed on the AR device screen 502.

The app running on the AR device analyzes the TV programming 503. In one embodiment the app running on the AR device attempts to recognize any watermarks that may be present there as a result of the AR data layer that was added to the original TV programming signal.

The app accesses data from TV programming database, current time, location etc. to obtain information about all programs available at the current time 504. Generally the TV screen implies any screen where the programming is being displayed e.g. when streaming a show on the monitor of a desktop or the screen of a laptop.

The app may use image recognition to identify the current program on TV display 505 for example by analyzing the unique “watermark” that is injected as the AR layer in the TV programming signal. Each TV program and time slot may have a different and unique watermark that uniquely recognizes it and assists in the injection of the virtual content in the AR space.

The app preferably injects stats and other data in the AR space on the AR device 506.

In some embodiments the injected virtual objects may also be accompanied with superimposed graphics, video, audio and other sensory enhancements like haptic feedback and smell to create a realistic augmented realty experience for the user.

In some embodiments a user may have to pay e.g. get a membership or a subscription for viewing the injected content. While in other embodiments the user may access the injected content using a pay as you go method of payment. Other embodiments may provide some free or subsidized content in compensation for watching and interacting with ads injected in the AR space.

In some embodiments once digital content has been injected into the AR space, a user may be able to interact with such content e.g. move a virtual 3D representation of a player by manipulating the controls to move the 3D content, change size, zoom in, zoom out, share, forward, save, buy a replica or create a 3D print etc.

In some embodiments the interaction may also include but is not limited to e.g. be able to visit the related website by virtually touching the digital content in the AR space by virtually touching the digital content and optionally paying for it with a digital payment method e.g. automatically paying from a credit card linked to the user's Smartphone, or using a PayPal account of the user and the like.

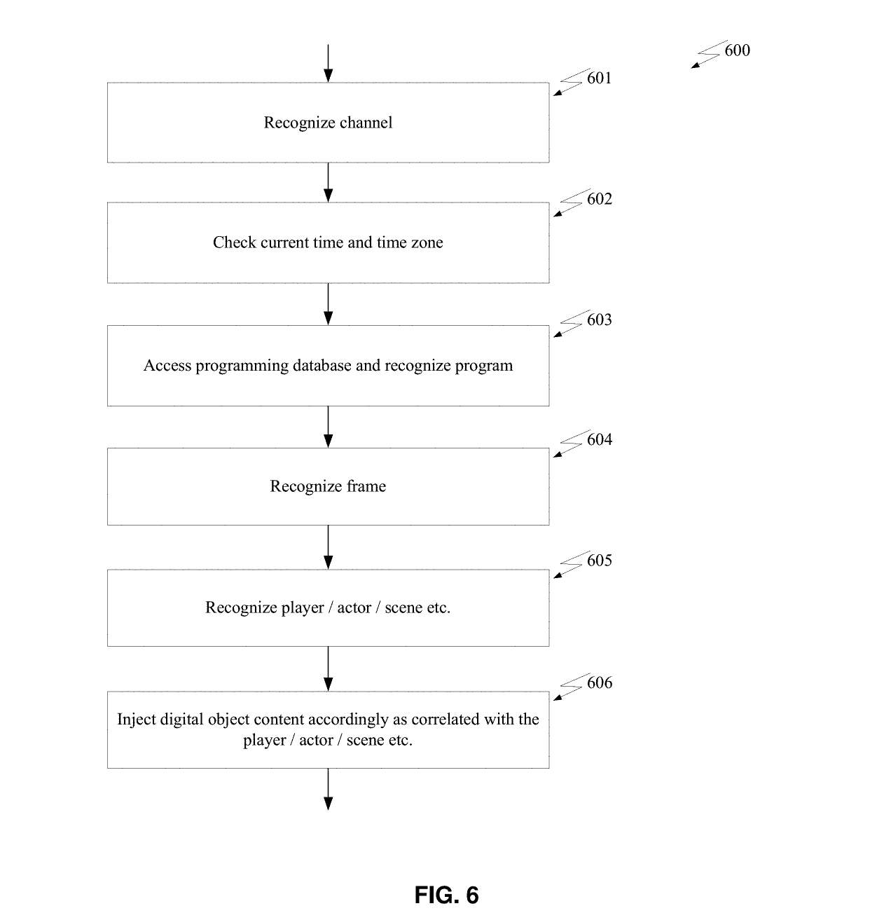

FIG. 6 provides a flow chart of the process of recognizing the channel being watched and the injection of appropriate content in the Augmented Reality space as correlated to the player/actor/scene on the display 600. Such a technique may either be used in the absence of the AR data layer or when the “watermark” in the AR data layer is not fully recognized.

The app recognizes the channel 601 on display on a television or monitor. There are thousands upon thousands of TV channels available to watch worldwide. For each channel, there's a logo design that is easily recognizable and often memorable. A digital on-screen graphic also known as digitally originated graphic is a watermark-like station logo that most television broadcasters overlay over a portion of the screen area of their programs to identify the channel. Digital on-screen graphics are thus a form of permanent visual station identification, increasing brand recognition and asserting ownership of the video signal. In some cases, the graphic also shows the name of the current program. Some TV networks use an on-screen graphic to advertise upcoming programs, usually programs scheduled later the same day, but also for “significant” upcoming programs as much as a week in advance.

The graphic identifies the source of programming, even if it has been time-shifted—that is, recorded to videotape, DVD, or a digital personal video recorder such as TiVo. Many of these technologies allow viewers to skip or omit traditional between-programming station identification; thus the use of a digital on-screen graphic enables the station or network to enforce brand identification even when standard commercials are skipped.

Channel recognition may be done by using the visual information e.g. TV station/channel logos that are displayed on the screen during normal broadcast and comparing that to the logos in a database. Third party online databases of television station logos are available and can be accessed via the internet. Alternatively the entire television station logos database may be downloaded and refreshed on an as need basis.

The system may check the current time and time zone 602, such as by accessing the local clock and setting on an AR device like a HMD or a Smartphone.

The system may access a programming database and recognize the program 603. TV programming schedules are usually published in advance and are available either directly via the broadcaster's infrastructure or indirectly via the third party consolidators who publish paper and online guides. Additionally much like the TV channels, many television programs also have individual and unique logos that can be used for recognizing the programs. Third party databases of logos of TV programs are available on line and can be accessed via the internet.

The system may recognize the specific frame 604 of the current program on the current channel on display.

The system may recognize the specific player/actor 605 in the current frame. In one embodiment the recognition may be achieved by using visual recognition techniques, while in another embodiment recognition may be achieved by using the information about cast and players and a combination of both visual recognition techniques and the retrieved and contextual information about the cast and players.

A digital object is injected accordingly as correlated with the player/actor/scene etc. 606.

In one embodiment a means is provided for a user to interact with the injected digital content e.g. a user may use any one of the several possible mechanisms to interact with the injected virtual objects in the AR space including but not limited to a touchscreen, keyboard, voice commands, eye movements, gamepad, mouse, joystick, wired game controller, wireless remote game controller or other such mechanism.

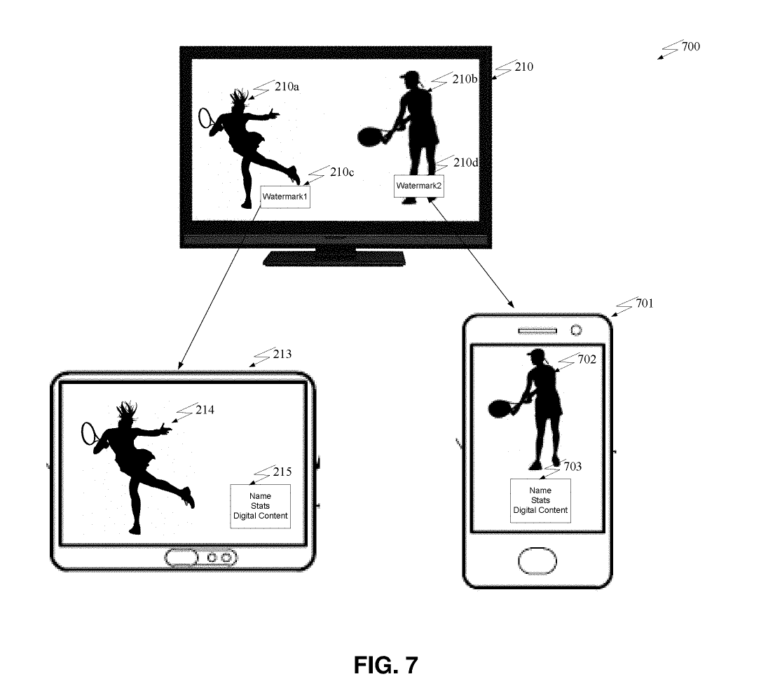

Referring to FIG. 7, a flow chart is shown of a simplified network where multiple (here, two) watermarks appear on the screen and inject different virtual objects in the Augmented Reality space for different viewers 700. Thus two or more different viewers can focus on different parts of the viewing screen (watermarks) and get different sets of information about items that appeal to their personal interests e.g. they are fans of different players and want information only about their favorite player.

The TV 210 or other viewing device e.g. a monitor is connected to a Set Top Box where a live game of tennis is being telecast.

There are multiple options on the viewing device 210 e.g. two players 210a and 210b, where more than one watermarks preferably one watermark uniquely associated with each of the players is available. In FIG. 7 the first player 210a has an associated watermark Watermark1 210c and the second player 210b has an associated watermark Watermark2 210d.

A first AR device 213 with a focus on a first player 210a and the associated watermark Watermark1 210c. First AR device 213 screen shows the image 214 of the first player and the injected digital content 215 associated with the first player 210a.

A second AR device 701 with a focus on a second player 210b and the associated watermark Watermark2 210d. Second AR device 701 screen shows the image 702 of the second player and the injected digital content 703 associated with the second player 210b.

In one embodiment using visual, auditory and/or haptic feedback the digital content may be displaced in the AR space in accordance with the user movements e.g. when the user moves and a different player comes in focus; inject information relevant to the current player in the field of view. For example when the first user points the first AR device 213 at the second player 210b, inject digital content associated with the second player 210b.

Tactile haptic feedback has become a commonly implemented technology in mobile devices, and in most cases, this takes the form of vibration response to touch. Haptic technology, haptics, or kinesthetic communication, is tactile feedback technology which recreates the sense of touch by applying forces, vibrations, air or motions to the user. This mechanical stimulation can be used to assist in the creation of virtual objects in a computer simulation, to control such virtual objects, and to enhance the remote control of machines and devices.

In one embodiment the digital information injected in the AR space may be refined, modified, filtered etc. based on a user profile, social interactions and other user characteristics or behavior. Thus the first user and the second user may be pointing their AR device towards the same player, but the injected digital content may be different based on the user personalities and interests.

In some embodiments each corner of the view may be associated with a different type of digital content such that one corner may have text, another audio, yet another video etc. associated with it and this digital content is then injected in the AR space when a user's mobile device camera is pointing at said corner.

For example in one embodiment digital content related to different seasons or games associated with a given player may be displayed on different sides of the AR device screen or display.

In another embodiment digital content whether 2D or 3D injected in the AR space may increase in complexity and extent based on user settings that are user changeable.

In some embodiments the content associated with a real world object (player/actor/program) may be gamified such that the user progresses from an easier level to a more complex level as the user interacts with the system.

In some embodiments the content associated with a real world object may be downloaded (either automatically or by user request) from a central server that acts as a repository for such digital and virtual content.

In one embodiment the user may have the means for controlling the type, extent and complexity of the content and virtual objects being injected in the AR space by using a GUI (Graphical User Interface) in the app to manage the settings. The user may be motivated to do so either to save time or conserve data usage.

In one embodiment age appropriate content may be displayed to a user based on the user's age; while the complexity and the extent of the content may also vary with age e.g. teens may be provided with a set of easy to understand information including gamified content (concept of applying game mechanics and game design techniques to engage and motivate users to achieve their goals); while older adults may be provided more in depth commentary and details. Preferably a user may be able to control the complexity and the extent of the content that is injected into the AR space e.g. a person who is keenly interested in gambling may want further information after having experienced the age appropriate content and may opt for advanced level information.

In one embodiment using an input device a user may be able to manipulate the digital content injected in the AR space; for example a user may employ one or more of the following to interact with the digital content:
Touchscreen interaction
Graphical menus
Voice commands
Gestural interaction
Virtual tools with specific functions

In one embodiment using visual, auditory and/or haptic feedback displace the digital content (virtual objects) other related content in the AR space. In one embodiment perform other interactive tasks in response to user input.

In some embodiments user interaction may consist of manipulating the injected digital content (virtual objects) in the AR space by moving, expanding, contracting, walking through, linking, and changing certain characteristics of the injected digital content.

In some other embodiments user interaction may consist of visiting a website e.g. Wikipedia by virtually touching the digital content in the AR space or buy a replica or other the product/service by virtually touching the digital content in the AR space and optionally paying for it with a digital payment method e.g. automatically paying from a credit card linked to the user's Smartphone, or using a PayPal account of the user and the like.

Examples of interaction with the digital content may include but are not limited to the following:
1. Re-locate (Translate)
2. Re-scale (Scale)
3. Re-orient (Rotate along X, Y and Z axis)
4. Zoom in and Zoom out
5. Read information (inject an image of text)
6. Listen to an audio clip (inject an audio clip)
7. Watch a movie (inject a movie clip)
8. Purchase a replica (of say a player)
9. Take a screen shot or make a movie of the virtual object injected in the AR space and share
10. Walk around the venue e.g. a stadium and see the hidden sides/areas not visible in the TV program being telecast by injecting a 3D virtual representation of such areas
11. Move around
12. Remove layers (inject multiple layers and remove layer by layer)

It should be noted that the size and scope of the digital content on the screen of the device is not limited to a particular portion of a user's field of vision as the digital content comprising the virtual content may extend throughout the screen of the mobile device or be sectioned to predetermined viewing dimensions, or dimensions in proportion to the size of the screen.

The digital content displayed on the screen of the mobile device being used for the Augmented Reality experience can be anchored to a particular volume of airspace corresponding to a physical location of the flat feature-rich surface. The mobile device being used for the Augmented Reality experience may display some, or all, of the digital content relative the orientation of the user or screen to the physical location of the flat feature rich surface. That is, if a user is oriented towards the physical location of the flat feature rich surface, the digital content is displayed, but gradually moved and eventually removed as the user moves to become oriented so that the physical location of the flat feature rich surface is not aligned with the user and the screen.

Although the digital content displayed on the screen is not limited to a particular size or position, various embodiments configure the screen of the mobile device being used for the Augmented Reality experience with the capability to render digital content as a variety of different types of media, such as two-dimensional images, three-dimensional images, video, text, executable applications, and customized combinations of the like.

One embodiment may preferably also provide a framework or an API (Application Programming Interface) that enables a developer to incorporate the functionality of injecting virtual objects/characters/content into an AR space when encountering a flat feature rich surface. Using such a framework or API allows for a more exciting Augmented Reality generation, and eventually allows for more complex and extensive ability to keep a user informed and engaged over a longer duration of time.

It should be understood that although the term app has been used as an example in this disclosure but in essence the term may also imply any other piece of software code where the embodiments of the invention are incorporated. The software application can be implemented in a standalone configuration or in combination with other software programs and is not limited to any particular operating system or programming paradigm described here.

Although AR has been exemplified above with reference to injecting virtual content related to sports and games, it should be noted that AR is also associated with many industries and applications. For example, AR can be used in movies, cartoons, computer simulations, medical diagnostics and imaging, video simulations, among others. All of these industries and applications would benefit from the invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of enabling enhanced viewing of a broadcast by a user through an augmented reality device, comprising:
providing an application on the augmented reality device which is programmed for:
acquiring a camera feed of at least a portion of a broadcast displayed on a display device, the broadcast including an AR layer;
displaying the camera feed using the augmented reality device;
recognizing in the AR layer of the acquired broadcast at least one watermark or image;
accessing a database of such watermarks or images, and retrieving related data; and
rendering the data or an associated virtual object as an overlay of the displayed camera feed.

2. The method of claim 1, wherein the camera feed and the overlay are displayed on a screen of the augmented reality device.

3. The method of claim 2, wherein the user is permitted to interact with the camera feed or the overlay on the screen of the augmented reality device.

4. The method of claim 3, wherein the screen is a touchscreen.

5. The method of claim 1, wherein at least a portion of the camera feed or the overlay is displayed in a 3D representation anchored to a particular volume of airspace.

6. The method of claim 5, wherein the 3D representation is manipulable by the user virtually touching the 3D representation in AR space.

7. The method of claim 6, wherein the 3D representation is manipulable by the user by: resizing, rescaling, relocating, zooming in/out, selecting, or reorienting the 3D representation.

8. The method of claim 7, wherein manipulators are provided for the user to perform interactions on the 3D representation.

9. The method of claim 7, wherein selecting includes linking, sharing, or changing characteristics.

10. The method of claim 1, wherein the watermark is a digital watermark which is substantially invisible to a viewer of the broadcast on the display device.

11. The method of claim 1, wherein the at least one watermark or image includes a plurality of watermarks or images, each being associated with distinct data.

12. The method of claim 1, wherein the image comprises an image of a character, place or scene in the broadcast.

13. The method of claim 1, wherein the image comprises a logo associated with a channel or network.

14. The method of claim 1, wherein the image comprises a QR code.

15. The method of claim 1, wherein the broadcast is a sports broadcast and the data includes at least one statistic.

16. The method of claim 1, wherein retrieving related data includes retrieving data from linked databases.

17. The method of claim 16, wherein the linked databases include at least one of program guide, wiki or other encyclopedic source, social media, statistical, or newsfeed databases.

18. The method of claim 1, wherein the associated virtual object is a virtual character or avatar.

19. The method of claim 1, further comprising retrieving information about the user through the application and tailoring the data or associated virtual object according to at least one interest or demographic variable of the user.

20. The method of claim 19, wherein the information is in a profile associated with the user.

21. The method of claim 20, wherein the profile is a social media profile.

22. The method of claim 19, wherein the demographic variable comprises age or gender of the user.

23. The method of claim 19, wherein the interest is an expressed preference of the user, or a preference gathered from past viewing or browsing behaviour of the user.

24. The method of claim 1, wherein the augmented reality device is a smartphone.

25. The method of claim 1, wherein the augmented reality device is a head-mounted device.

26. The method of claim 1, wherein the display device is a television.
